(19) United States
(12) Patent Application Publication
(10) Pub. No.: US 2023/0216825 A1
(43) Pub. Date: Jul. 6, 2023

(54) GATEWAY BASED IP ADDRESS TRANSLATION IN COMMUNICATION NETWORKS

(71) Applicant: T-Mobile Innovations LLC, Overland Park, KS (US)

(72) Inventor: Grzegorz Wosik, Bellevue, WA (US)

(21) Appl. No.: 17/567,001

(22) Filed: Dec. 31, 2021

(51) Int. Cl. H04L 61/251; H04L 101/686; H04L 61/4511; H04L 61/4552

(52) U.S. Cl. CPC H04L 61/251; H04L 61/6086; H04L 61/1511; H04L 61/1552

(57) ABSTRACT

Systems, methods, and computer-readable media herein provide for gateway based IP address translation in communication networks. Data associated with an IPv4 address is received by a network gateway device which maintains an IPv4 to IPv6 mapping table that may population with information queried from DNS servers. The mapping table may be accessed to determine a destination IPv6 address enabling received data to be modified to use the IPv6 address to natively access IPv6 Internet resources and domains.

### BACKGROUND

Networks, such as the Internet, use a Domain Name System (“DNS”) that provides domain name information for resources connected to the network. Domain name information may include an Internet Protocol address (“IP address”) that provides the location of various hosts connected to the network. Communications over a network may include one or more IP addresses with each packet of transmitted data that indicate the IP address of the sending device and the IP address of the receiving or destination device. As such, every host on a network will have a particular address assigned to it. IP addresses may be expressed in different formats. Many Internet connected devices had used the Internet Protocol version 4 (“IPv4”) protocol for network addressing. Due to the rapidly increasing number of hosts connecting to the Internet, a newer protocol—Internet Protocol version 6 (“IPv6”)—was defined to have a greater addressing space (e.g., number of possible distinct IP addresses) than was available with IPv4. Although, many network connected devices operate on the IPv6 protocol, many devices continue to operate under the IPv4 protocol. As such, there is a continued need for interoperability between these two addressing protocols.

Interoperability between IPv4 and IPv6 necessitates various steps to be taken by devices connect to a network. Certain hosts may only be configured to operate under IPv4, while other hosts may operate exclusively under IPv6, and still others may operate according to IPv4 and/or IPv6. When a host operates exclusively on one addressing protocol, each communication to another host that operates on a different addressing protocol must undergo one or more translation operations such as network address translation (NAT). For instance, data packets transmitted from an IPv4 exclusive host to an IPv6 exclusive destination host must have the associated IPv4 addresses translated to IPv6 addresses. This additional address translation requires network and computational resources and as a result, may place a burden on a network provider's (e.g., internet service provider) resources. Additionally, the address translation operations take additional computational complexity when compared to accessing a destination host using its native addressing protocol. This additional computational complexity may increase the latency for a user accessing a network destination and result in a diminished user experience.

Providing compatibility for IPv4 and IPv6 is especially relevant for network gateway device that direct transmitted data packets using a destination IP address. Often, network gateway devices, such as a residential or home internet gateway, are configured to operate exclusively on the newer IPv6 protocol, while associated client devices (e.g., PC, TV, appliances, IoT devices, etc.) within a private (e.g., home network, WiFi network, LAN, etc.) connected to the network gateway device may operate exclusively with IPv4. Increasingly, many Internet services (e.g., websites, streaming, etc.) may operate using either IPv4 or IPv6. In such a scenario, an IPv4 client attempting to send uplink communications to a destination IPv4 Internet service would require an intermediate IPv6 network gateway device to first translate the IPv4 address from the client device into a synthesized IPv6 address that is subsequently translated into an IPv4 address by the network provider for routing to the destination Internet service. Translating an IPv4 address to an IPv6 address and then back to an IPv4 address involves computing and network resources of both the network gateway device and the network provider since an IP address must be translated for each packet of transmitted data.

### SUMMARY

The present disclosure is directed, in part, to gateway based IP address translation in communication networks, substantially as shown in and/or described in connection with at least one of the figures, and as set forth more completely in the claims. In contrast to conventional approaches, a mapping table is used by a network gateway device to determine an IPv6 address associated with a destination (e.g., internet service, website, etc.). An IPv4 address may be received from a client device (e.g., computer, TV, IoT device, etc.) and used to determine a corresponding IPv6 address in the mapping table. If a corresponding IPv6 address is found in the mapping table, the IPv6 address can be used to transmit data packets to the IPv6 enabled destination, without needing additional translation to a synthesized IPv6 address and a resulting IPv4 destination address. The mapping table can operate statically, where the table can be pre-populated with one or more mappings of IPv4 addresses to corresponding IPv6 addresses. The mapping table may comprise allow-lists and deny-lists that enable or disable particular addresses for translation. In certain embodiments, the mapping table may operate dynamically, where IPv4 to IPv6 address mappings may be added to the mapping table. The mappings may be added to the mapping table in response to a query to one or more DNS servers. A DNS query from an IPv4 exclusive client device may cause a network gateway device to request both an IPv4 and IPv6 address for the desired destination from a DNS server. The IPv4 address and the IPv6 address may be added to the mapping table as part of a mapping.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Implementations of the present disclosure are described in detail below with reference to the attached drawing figures, which are intended to be exemplary and non-limiting, wherein:

FIG. 1 depicts a diagram of an exemplary network environment in which implementations of the present disclosure may be employed;

FIG. 2 depicts a flow diagram illustrating an example method for gateway based IP address translation in communication networks, in accordance with embodiments of the present disclosure;

FIG. 3 depicts a flow chart of a method for gateway based IP address translation in communication networks, in accordance with aspects of the present disclosure;

FIG. 4 depicts a flow chart of a method for gateway based IP address translation in communication networks, in accordance with aspects of the present disclosure;

FIG. 5 depicts a flow chart of a method for gateway based IP address translation in communication networks, in accordance with aspects of the present disclosure; and

FIG. 6 depicts a diagram of an exemplary computing environment suitable for use in implementations of the present disclosure.

### DETAILED DESCRIPTION

The subject matter of embodiments of the invention is described with specificity herein to meet statutory requirements. However, the description itself is not intended to limit the scope of this patent. The claimed subject matter might be embodied in other ways to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout the description of the present invention, several acronyms and shorthand notations are used to aid the understanding of certain concepts pertaining to the associated system and services. These acronyms and shorthand notations are solely intended for the purpose of providing an easy methodology of communicating the ideas expressed herein and are in no way meant to limit the scope of the present invention.

Further, various technical terms are used throughout this description. A definition of such terms can be found in, for example, Newton's Telecom Dictionary by H. Newton, 31st Edition (2018). These definitions are intended to provide a clearer understanding of the ideas disclosed herein but are not intended to limit the scope of the present invention. The definitions and terms should be interpreted broadly and liberally to the extent allowed by the meaning of the words offered in the above-cited reference.

Embodiments of the technology may be embodied as, among other things, a method, system, or computer-program product. Accordingly, the embodiments may take the form of a hardware embodiment, or an embodiment combining software and hardware. In one embodiment, the present invention takes the form of a computer-program product that includes computer-useable instructions embodied on one or more computer-readable media.

Computer-readable media includes volatile and/or nonvolatile media, removable and non-removable media, and contemplate media readable by a database, a switch, and various other network devices. Network switches, routers, and related components are conventional in nature, as are means of communicating with the same. By way of example and not limitation, computer-readable media comprise computer storage media and/or communications media. Computer storage media, or machine-readable media, include media implemented in any method or technology for storing information. Examples of stored information include computer-useable instructions, data structures, program modules, and other data representations. Computer storage media include RAM, ROM, EEPROM, flash memory or other memory technology, CD-ROM, digital versatile discs (DVDs), holographic media or other optical disc storage, magnetic cassettes, magnetic tape, magnetic disc storage, and/or other magnetic storage devices. These memory components can store data momentarily, temporarily, or permanently. Computer storage media does not encompass a transitory signal, in embodiments of the present invention.

Communications media typically store computer-useable instructions, including data structures and program modules, in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

At a high level, systems, methods, and computer-readable media of the present invention provide an IPv4 to IPv6 translation using a network gateway device and assisted by a DNS system. The systems, methods, and computer-readable media disclosed herein may provide a faster and more efficient access to IPv6 domains when using an IPv6 exclusive network gateway device. By using a mapping table with mappings between IPv4 and IPv6 domains, the domain address of a data packet may only have to be translated a single time. For example, an IPv4 based device trying to access an IPv6 enabled domain using an IPv6 network gateway device, may transmit a data packet with an associated IPv4 address which may be translated to an IPv6 address using the mapping table. Further, subsequent data packets targeting the same domain can use previously generated mapping such that the IPv4 and IPv6 addresses associated with the destination domain do not have to be requested from a DNS system and mapped to each other.

In a first aspect of the present disclosure, a method is provided. In embodiments, the method comprises receiving a first data packet. The data packet may include a first IP address and/or a second IP address. For example, the first IP address and the second IP address may be received from one or more DNS servers of a DNS system that provide domain information such as one or more IP addresses in response to query and/or request. In embodiments, the method comprises generating a mapping of the first IP address to the second IP address. For example, the first IP address and the second IP address may be associated with a particular domain (e.g., website), such that the first IP address and the second IP address may be mapped to each other based on their respective associations with that particular domain. In some embodiments, a first lookup request is generated. For example, a first lookup request may be generated to include the first IP address. In some examples, the first lookup request may be used to query a mapping table. For example a lookup request including the first IP address may be used to query a mapping table to retrieve the second IP address based on the mapping of the first IP address to the second IP address. In some embodiments, the method comprises transmitting a first address data with the second IP address. For example, based on the first lookup request and the mapping of the first IP address to the second IP address, first address data associated with the second IP address may be transmitted. In certain embodiments, the method may comprise receiving a second data packet comprising the first IP address. For example, the second data packet may be received from a client device operating on a local area network associated with a network gateway device. In embodiments, a second lookup request may be generated based on receiving the second data packet. For example, the second data packet may include the first IP address. In some embodiments, the method comprises transmitting a second address data associated with the second IP address base on the second lookup request and the mapping of the first IP address to the second IP address.

In other embodiments, a network addressing system comprising one or more processors configured to receive a first data packet including a first IP address form a client device. For example a data packet with an IPv4 IP address may be received from a client device (e.g. computer, television, appliance, etc.) that operates using the IPv4 protocol. In some embodiments, the system is configured to access a mapping table to determine a second IP address. For example, using an IPv4 address received from a client device, a mapping table comprising a mapping of various IPv4 addresses to IPv6 addresses, may be accessed to determine an IPv6 address. In some instances, a first translated data packet may be generated to include at least the second IP address. For example, the first translated data packet may represent a modification of the first data packet from the client device such that the determined second IP address is appended, or otherwise included, in the data packet. In some embodiments, a second data packet may be received, the second data packet including the first IP address. For example, a second data packet may be received from the client device, the data packet including information such as the same IP address of the first data packet and/or previous data packets. In some embodiments, the mapping table can be access using the first IP address that way included in the second data packet. For instance, accessing the table with the first IP address from the second data packet may determine the same second IP address as when the mapping table was accessed using the first IP address from the first data packet since the first IP address remains the same between the first data packet and the second data packet. In some embodiments, a second translated data packet may be generated to include the second IP address. The second translated data packet may be transmitted to a destination associated with the second IP address.

In still other embodiments, one or more computer-readable media having computer-executable instructions embodied thereon that, when executed, perform a method that may comprise transmitting an IPv4 address and a packet of data to a network gateway device. For example the packet data may include and/or correspond to the IPv4 address. In some examples, the network gateway device is configured to operate using an IPv6 protocol. In some embodiments, the method may comprise causing the network gateway device to query a mapping table using the transmitted IPv4 address to determine an associated IPv6 address. In some embodiments, the method may comprise causing the network gateway device to transmit the packet of data to a destination associated with the IPv6 address. For example, the packet of data that is transmitted to the network gateway device may have the IPv6 address determined using the mapping table, appended or associated to the packet of data such that the network gateway device may transmit the packet of data to a destination (e.g., an internet domain) using the IPv6 address.

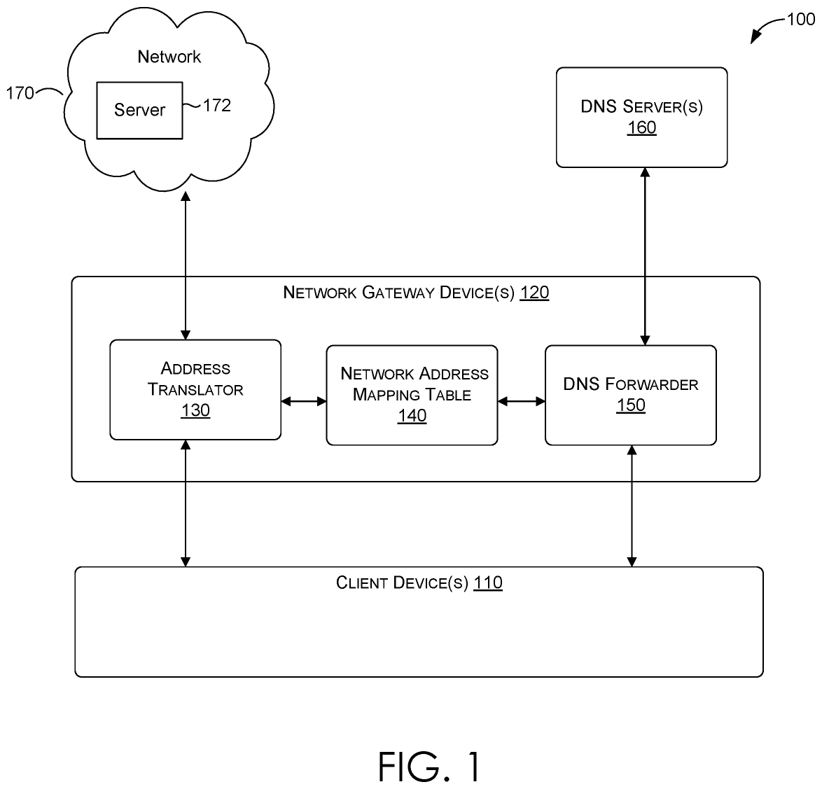

Turning now to FIG. 1, system 100 is an exemplary environment in which implementation of the present disclosure may be employed. System 100 is one example of a suitable environment and is not intended to suggest any limitation as to the scope of use or functionality of the present disclosure. Neither should the system 100 be interpreted as having any dependency or requirement relating to any one or combination of components illustrated.

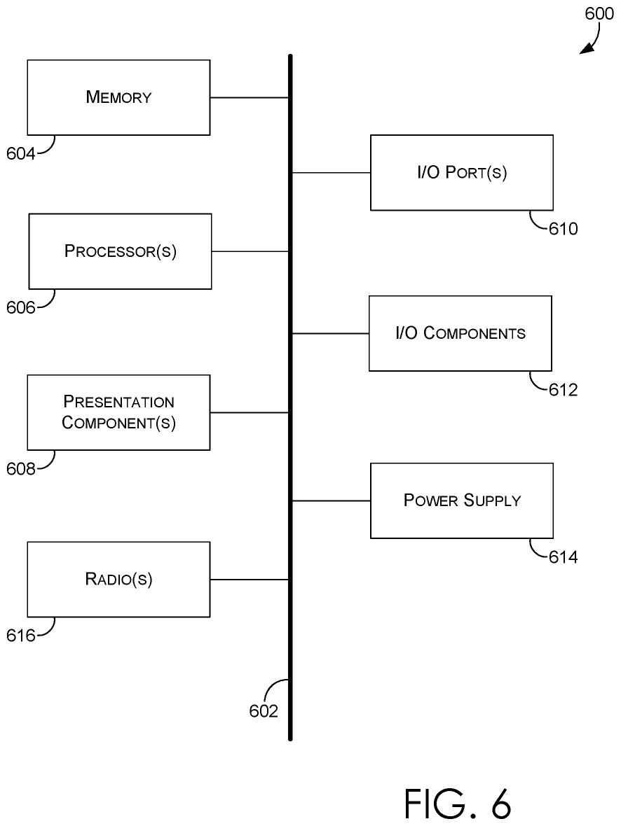

The system 100 may include, among other things, client device(s) 110, network gateway device(s) 120, DNS server(s) 160, and a network 170. In any example, there may be any number of client device(s) 110, network gateway device(s) 120, and DNS server(s) 160. The system 100 (and the components and/or features thereof) may be implemented using one or more computing devices, such as the computing device 600 of FIG. 6, described in more detail below.

The system 100 facilitates service to one or more client device(s) 110. In some embodiments, the system 100 may be a telecommunication network (e.g., a telecommunication network such as, but not limited to, a wireless telecommunication network), or portion thereof. The system 100 may include one or more devices and components, such as base stations, servers, switches, relays, amplifiers, databases, nodes, etc. which are not shown so as to not confuse other aspects of the present disclosure. Those devices and components may provide connectivity in a variety of implementations. In addition, the system 100 may be utilized in a variety of manners, such as a single network, multiple networks, or as a network of networks, but, ultimately, is shown as simplified as possible to avoid the risk of confusing other aspects of the present disclosure.

The client device(s) 110 may include a smart phone, a laptop computer, a tablet computer, a desktop computer, and/or another type of device capable of requesting and/or accessing a network, such as network 170. By way of example and not limitation, the client device(s) 110 may be embodied as a Personal Computer (PC), a laptop computer, a mobile device, a smartphone, a tablet computer, a smart watch, a wearable computer, a virtual reality device, an augmented reality devices, any combination of these delineated devices, or any other suitable device.

In the system 100, a client device (s) 110 (e.g., a mobile device, personal computer, etc.) is illustrated and able to communicate with other devices (e.g., a mobile device(s), a server(s), a personal computer(s), etc.), by way of one or more network gateway device(s) 120. The network gateway device(s) 120 might include an array of devices or components, some of which are not shown so as not to obscure more relevant aspects of the invention. The network gateway device(s) 120 may include an address translator 130, a network address mapping table 140, and a DNS forwarder 150. Other components such as terminals, links, and nodes (as well as other components) can provide connectivity in some embodiments. The network gateway device(s) 120 can include multiple networks, as well as being a network of networks. In embodiments, the network gateway device(s) 120 can be associated with a telecommunications provider that provides services to client devices, such as client device(s) 110.

While a single client device(s) 110 (e.g., a mobile device) is illustrated in system 100, it should be understood that any number of client devices may communicate by way of a network gateway device(s) 120. For instance, in some embodiments, some network gateway devices may serve large quantities of client devices, while in other embodiments, network gateway devices may serve smaller quantities of client devices. As such, the quantity of client devices illustrated in system 100 is shown just for exemplary purposes, and is not meant to limit embodiments presented herein in any way.

The network gateway device(s) 120 may include an address translator 130, a network address mapping table 140, an/or a DNS forwarder 150. Although only a few components and/or features of the client device(s) 102 are illustrated in FIG. 1, this is not intended to be limiting. For example, the client device(s) 110 may include additional or alternative components, such as those described with respect to the computing device 600 of FIG. 6.

The network gateway device(s) 120 is the link between the client device(s) 110 and access to servers, such as server 172 by way of the network 170. In certain embodiments, the network gateway device(s) 120 may be a packet data network (PDN) gateway (P-GW). Additionally, the client device(s) 110 may be connected to multiple network gateway device(s) 120, instead of just one, as shown in FIG. 1. In aspects described herein, the network gateway device(s) 120 may assists in communications when a client device requests to access content from a website or server 172 on the network 170.

In aspects described herein, the network gateway device(s) 120 assigns or allocates various parameters to client devices during authentication of those user devices onto the network. As will be described further herein, the network gateway device(s) 120 utilize logic that allows it to determine, for example, which addressing scheme to assign to a particular client device. In part, this assignment is based on the IP version capabilities of the client device. In an embodiment, requests from a client device(s) 110 are sent through the network gateway device(s) 120 and when an external IP address is needed, the request is routed to the destination server 172 by way of the network 170.

The network address mapping table 140 (e.g., mapping table) includes one or more components suitable for storing and/or organizing information associated with domain names and corresponding IP addresses. For example, the network address mapping table 140 may include one or more databases that may include domain names and IPv4 and/or IPv6 addresses. In some embodiments, the contents of the network address mapping table may be, at least in part, may be provided in response to a DNS query from the DNS forwarder 150. For example, the network address mapping table 140 may include a record of a domain name and IP address that was previously retrieved from a DNS server(s) 160 by the DNS forwarder 150. In the same or other embodiments, the network address mapping table may include information associated with domain names and/or IP addresses that was received from sources other than the DNS forwarder 150. For example, the contents of the network address mapping table 140 may be predetermined (e.g. pre-loaded) or updated using one or more networks associated with the network gateway device(s) 120.

The network address mapping table 140 may include one or more mappings of IPv4 addresses to IPv6 addresses. For example, the network address mapping table 140 may include an IPv4 and an IPv6 address corresponding to a particular domain name. In such an example, the IPv4 address and/or the domain name may be used to lookup, or otherwise determine, the corresponding IPv6 address in the network address mapping table 140. In some embodiments, a lookup request may be provided to the network address mapping table 140. The lookup request may include information such as an IPv4 address that may be used to determine a corresponding IPv6 address in the network address mapping table 140. The network address mapping table 140 may receive a lookup request from the address translator 130.

Address translator 130 may comprise one or more components that facilitate the addressing and handling of data packets. For example, the address translator 130 may receive a data packet from the client device(s) 110 that has an associated IP address (IPv4 Address) that can be used by the address translator 130 to access and/or query the network address mapping table 140 to determine an IPv6 address that is a match, or otherwise corresponds to, the IP address received from the client device(s) 110. In some embodiments, the address translator 130 may determine that there is not an IP address in the network address mapping table 140 which corresponds to a data packet received from a client device(s) 110. For example, a data packet from the client device(s) 110 may have an IPv4 address that has no corresponding IPv6 address stored in the network address mapping table 140. In such an example where a mapping cannot be used, the IPv4 address may be translated locally on the network gateway device(s) 120 into a synthesized IPv6 address that must subsequently be translated back into the IPv4 address—by a translator operated by the service provider.

The DNS forwarder 150 may comprise one or more components that facilitate the handling of DNS queries. For example, the client device(s) 110 may transmit a DNS query to the DNS forwarder 150 requesting the IP address for a desired domain, such as the server 172 access via the network 170. The client device(s) 110 may present a DNS query include a domain name (e.g., URL) of an intended network destination. The DNS forwarder may attempt to resolve a received DNS query by determining an IP address associated with the DNS query. In some embodiments, the DNS forwarder 150 may forward a DNS query to one or more DNS server(s) 160 that may resolve a domain name associated with the DNS query by looking up the corresponding IP address. In some embodiments the DNS query may be associated with an IPv4 address (e.g., an A query), while in the same or different embodiments, the DNS query may be associated with an IPv6 address (e.g., an AAAA query). In some embodiments, the DNS server(s) 160 may return an IP address based on an IPv4 protocol and/or an IPv6 protocol. For example, the DNS servers(s) 160 may return an IPv4 address in addition to an IPv6 protocol that the DNS forwarder 150 may forward to the client device(s) 110.

In at least one embodiment, the DNS forwarder 150 may, in response to a DNS query from a client device(s) 110, may attempt to resolve the domain name associated with the query by searching, or otherwise looking up, the corresponding IP addresses in one or more address caches, data stores, and/or tables. For example, upon receiving a DNS query from the client device(s) 110, the DNS forwarder 150 may first attempt to locate the corresponding IP address in the network address mapping table 140 before resolving the DNS query via the DNS server(s) 160. In such an example, if the DNS forwarder 150 does not resolve the DNS query by accessing the network address mapping table 140, the DNS forwarder 150 may forward the DNS query to the DNS server(s) to determine the appropriate IP address.

In some embodiments, the DNS forwarder may provide one or more IP addresses to the network address mapping table. For example, the DNS forwarder may receive one or more IP addresses from the DNS server(s) 160 in response to forwarded DNS queries that may be provided to the network address mapping table 140 such that the one or more IP addresses may be accessed to resolve subsequent DNS queries without the DNS forwarder 150 having to access the DNS server(s) which may be external to the network gateway device(s) 120. The IP addresses retrieved by the DNS forwarder from the DNS server(s) may be appended and/or updated into the network address mapping table 140.

Having described system 100 and components operating therein, it will be understood by those of ordinary skill in the art that the network environment 100 is but an example of a suitable network and is not intended to limit the scope of use or functionality of aspects described herein. Similarly, network environment 100 should not be interpreted as imputing any dependency and/or any requirements with regard to each component and combination(s) of components illustrated in FIG. 1. It will be appreciated by those of ordinary skill in the art that the number, interactions, and physical location of components illustrated in FIG. 1 is an example, as other methods, hardware, software, components, and devices for establishing one or more communication links between the various components may be utilized in implementations of the present invention. It will be understood to those of ordinary skill in the art that the components may be connected in various manners, hardwired or wireless, and may use intermediary components that have been omitted or not included in FIG. 1 for simplicity's sake. As such, the absence of components from FIG. 1 should not be interpreted as limiting the present invention to exclude additional components and combination(s) of components. Moreover, though components may be represented as singular components or may be represented in a particular quantity in FIG. 1 it will be appreciated that some aspects may include a plurality of devices and/or components such that FIG. 1 should not be considered as limiting the quantity of any device and/or component.

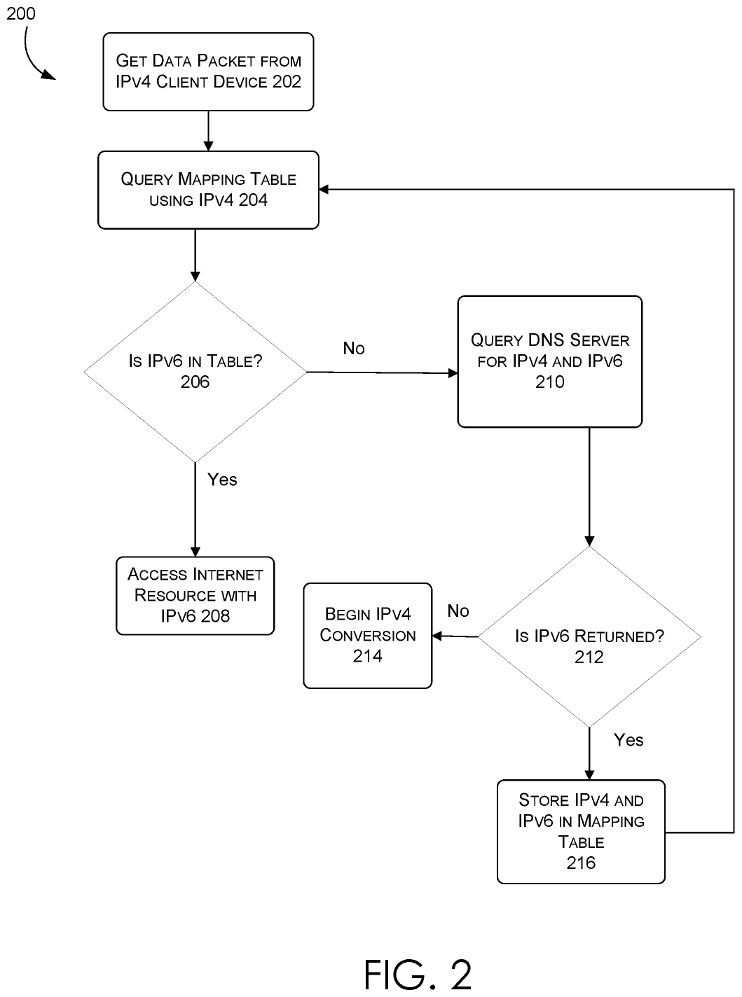

FIG. 2 depicts a flow diagram illustrating an example method 200 for gateway based IP address translation in communication networks, in accordance with embodiments of the present disclosure. More particularly, FIG. 2 illustrates an example method for generating IPv4 to IPv6 mapping that can be used to by a network gateway device to direct data packets associated with an IPv4 address to a destination Internet domain or destination resource that uses an IPv6 address. At step 202 of method 200, a data packet may be received from a client device. For example, the data packet may correspond to uplink data traffic to an Internet resource (e.g., website). The data packet may be a frame of data and/or may comprise a string or stream of data. In some embodiments, the data packets may comprise header information or other information that acts as an indication of an IP address associated with an intended Internet destination. In some examples, if the client device operates in part on an IPv4 protocol, the received data packets may comprise an IPv4 address.

At step 204 of method 200, a mapping table is queried using the IPv4 received from the client device. In some embodiments, the mapping table is configured to allow for the storage and management of IPv4 to IPv6 address mappings that allow for an IPv6 address that corresponds to a particular IPv4 address to be returned in response to a query. In some embodiments, the query to the mapping table may be made with the IPv4 address, while in the same or different embodiments, a query may be made with other parameters such as domain name, domain alias, and/or any other information relevant to retrieval of an IPv6 address.

At step 206 of method 200, it is determined whether an IPv6 address corresponding to the query exists in the mapping table. In some embodiments, if the IPv6 address is present in the mapping table, the data packet received from the client device may be modified to use the IPv6 address in place of the previous IPv4 address such that the IPv6 based Internet resource may be accessed. In some embodiments, modifying the data packets with the IPv6 address may involve modifying the contents, arrangement, and/or structure of the data packets and the associated header data. Once the data packet has been modified, the IPv6 Internet resource may be accessed as in step 208.

At step 210 of method 200, if the IPv6 address cannot be retrieved in step 206, the IPv6 address may be queried from one or more DNS servers. A query (e.g., an A query, an AAAA query, etc.) may be made to a DNS server to retrieve an IPv4 and/or and IPv6 address. The query to the DNS servers may involve using a domain name or alias to retrieve the associated IPv4 and IPv6 addresses.

At step 212 of method 200, it is determined whether the desired IPv6 address can be retrieved from the DNS servers. In some circumstances, an IPv6 address may not be available or exist on the DNS servers and a query would not return a result. In step 214 of method 200, if an IPv6 address cannot be determined by querying the DNS servers, the process of converting the IPv4 address received from the client device to a synthesized IPv6 address (e.g., an IPv6 address that must be converted back into IPv4 by the network provider) may commence. In some embodiments, subsequent data packets that are received may automatically undergo conversion to a synthesized IPv6 address, without continually querying the DNS servers.

In step 216 of method 200, if an IPv6 is returned by the DNS servers in response to the query, a mapping of the IPv4 address to the IPv6 address may be added, appended to, and/or updated within the mapping table. In some embodiments, once the mapping has been added to the mapping table, subsequent data packets with IPv4 addresses corresponding to the mapping, may be automatically converted to the IPv6 address associated with the mapping such that the data packets may be transmitted to the destination Internet resource without conversion back to IPv4 by the service provider.

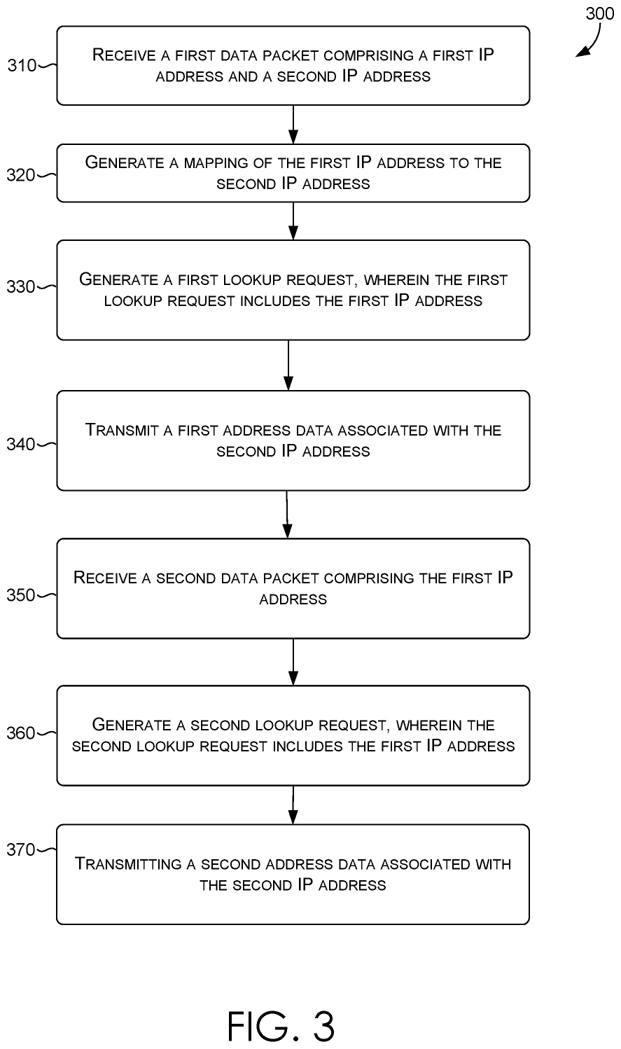

Now referring to FIGS. 3-5, each block of methods 300, 400, and 500, described herein, comprises a computing process that may be performed using any combination of hardware, firmware, and/or software. For instance, various functions may be carried out by a processor executing instructions stored in memory. The methods 300, 400, and 500 may also be embodied as computer-usable instructions stored on computer storage media. The methods 300, 400, and 500 may be provided by a standalone application, a service or hosted service (standalone or in combination with another hosted service), or a plug-in to another product, to name a few. In addition, the methods 300, 400, and 500 are described, by way of example, with respect to the system of FIG. 1. However, these methods may additionally or alternatively be executed by any one system, or any combination of systems, including, but not limited to, those described herein.

FIG. 3 is a flow chart illustrating an example method 300 for gateway based IP address translation in communication networks, in accordance with aspects of the present disclosure. It should be understood that while FIG. 3 depicts just one particular arrangement and/or order of steps, other arrangements and/or orders of steps are possible and contemplated by the disclosed herein. For instance, one or more of the steps depicted in FIG. 3, may be performed in a different order or otherwise omitted.

At step 310 of the method 300, a first data packet is received. For example, a data packet may be received by the network gateway device(s) 120. In some embodiments, the first data packet may comprise a first IP address and a second IP address. For example, the network gateway device(s) 120 may receive a data packet that includes an IPv4 address and an IPv6 address. In some embodiments, the first data packet may be received in response to a query made to one or more DNS servers. For example, a query may be made to the DNS server(s) 160 to retrieve IPv4 and/or IPv6 addresses.

At step 320 of method 300, a mapping of the first IP address to the second IP address is generated. For example, a mapping of the first IP address to the second IP address may be created by network gateway device(s) 120 and stored within a network address mapping table 140. In some embodiments, the mapping of the first IP address to the second IP address may be compared to an alloy-list and/or a deny-list to determine whether to add the mapping to the network address mapping table 140. For example, a deny-list may comprise an indication that a particular IP address and/or domain is not to be added to the network address mapping table 140. In some embodiments, the DNS forwarded may be configured to maintain the mappings included in the network address mapping table 140.

At step 330 of the method 300, a first lookup request may be generated, wherein the first lookup request includes the first IP address. For example, the network gateway device(s) may receive a data packet that includes the first IP address (e.g., a IPv4 address) and in response may generate a lookup request that can be used by address translator 130 to retrieve the second IP address (e.g., the IPv6 address) from the network address mapping table 140.

At step 340 of method 300, a first address data is transmitted. In some embodiments, the first address data may be associated with the second IP address. For example, the network gateway device(s) 120 may transmit a data packet with first address data that is associated with the second IP address (e.g., IPv6 address) to a destination or server 172 on the network 170.

At step 350 of method 300, a second data packet comprising the first IP address (e.g., IPv4 address) may be received. For example, the network gateway device(s) 120 may receive a second data packet from a client device(s) 110.

At step 360 of method 300, a second lookup request may be generated, wherein the second lookup request includes the first IP address. For example, the network gateway device(s) may receive a data packet that includes the first IP address (e.g., a IPv4 address) and in response may generate a second lookup request that can be used by address translator 130 to retrieve the second IP address (e.g., the IPv6 address) from the network address mapping table 140.

At step 370 of method 300, a second address data is transmitted. In some embodiments, the second address data may be associated with the second IP address. For example, the network gateway device(s) 120 may transmit a data packet with second address data that is associated with the second IP address (e.g., IPv6 address) to a destination or server 172 on the network 170.

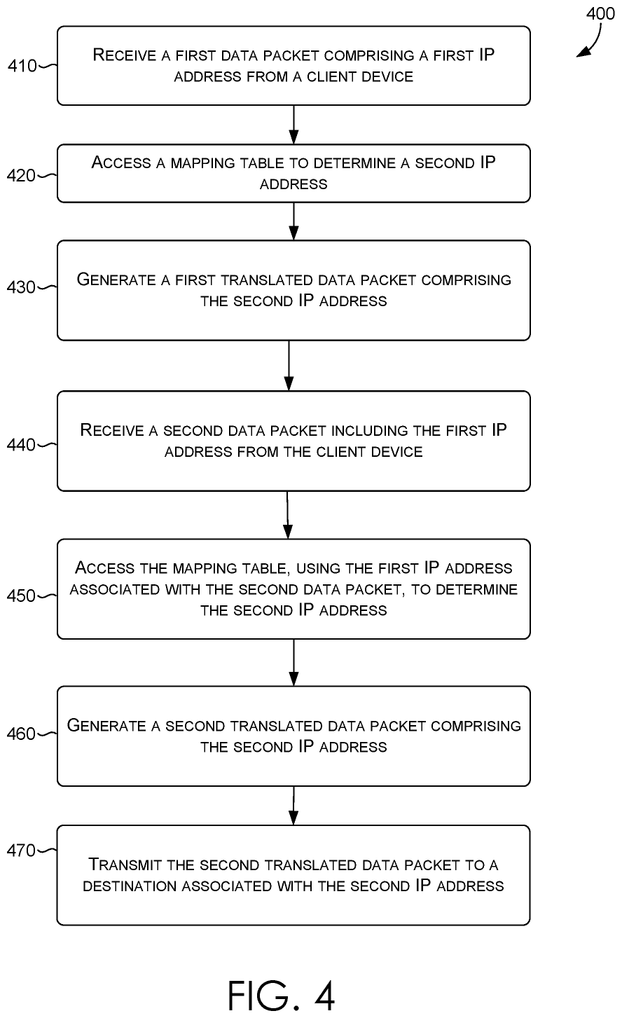

FIG. 4 is a flow chart illustrating an example method 400 for gateway based IP address translation in communication networks, in accordance with aspects of the present disclosure. It should be understood that while FIG. 4 depicts just one particular arrangement and/or order of steps, other arrangements and/or orders of steps are possible and contemplated by the disclosed herein. For instance, one or more of the steps depicted in FIG. 4, may be performed in a different order or otherwise omitted.

At step 410 of the method 400, a first data packet is received from a client device. For example, a data packet may be received by the network gateway device(s) 120. In some embodiments, the first data packet may comprise a first IP address. For example, the network gateway device(s) 120 may receive a data packet that includes an IPv4 address.

At step 420 of method 400, a mapping table may be accessed to determine a second IP address. For example, the address translator 130 may use the first IP address in a query to the network address mapping table 140 to determine a second IP address (e.g., IPv6 address).

At step 430 of the method 400, a first translated data packet comprising the second IP address may be generated. For example, the second IP address determined using the network address mapping table 140 may be used to modify the first data packet such that it is associated with the second IP address in a first translated data packet. In some embodiments, the first translated data packet will be associated with an IPv6 address.

At step 440 of method 400, a second data packet is received from a client device. For example, the second data packet may be received by the network gateway device(s) 120. In some embodiments, the second data packet may comprise the first IP address. For example, the network gateway device(s) 120 may receive a second data packet that includes the same IPv4 address as in step 410.

At step 450 of method 400, the mapping table may be accessed using the first IP address associated with the second data packet to determine the second IP address. For example, the address translator 130 may use the first IP address associated with the second data packet in a query to the network address mapping table 140 to determine the second IP address (e.g., IPv6 address).

At step 460 of method 400, a second translated data packet comprising the second IP address may be generated. For example, the second IP address determined using the network address mapping table 140 may be used to modify the second data packet such that it is associated with the second IP address in the second translated data packet. In some embodiments, the second translated data packet will be associated with an IPv6 address.

At step 470 of method 400, the second translated data packet may be transmitted to a destination associated with the second IP address. For example, the network gateway device(s) 120 may transmit the second translated data packet to a destination or server 172 on the network 170 that is associated with the second IP address.

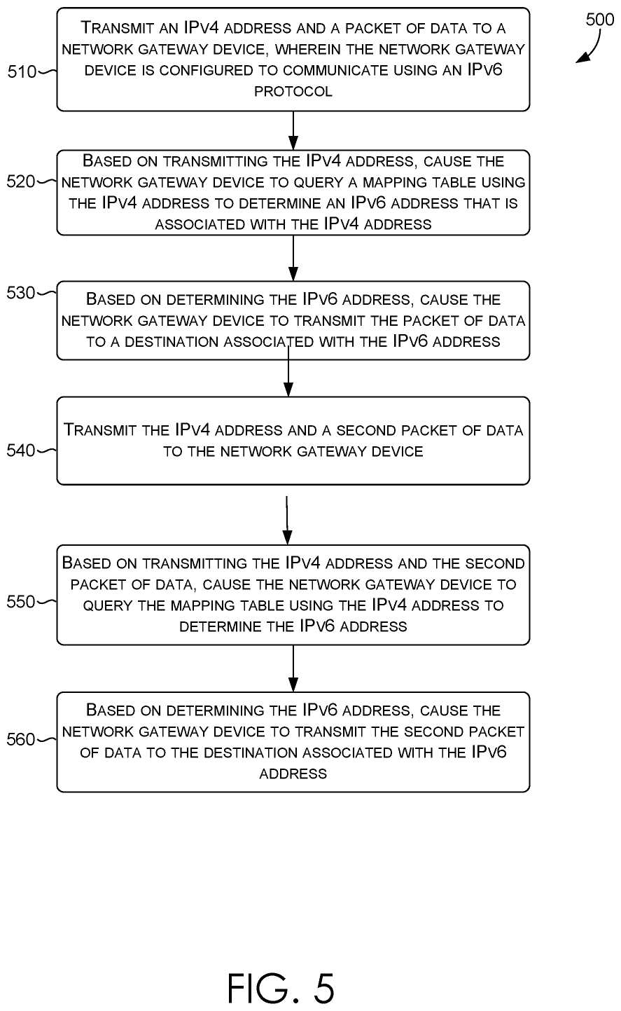

FIG. 5 is a flow chart illustrating an example method 500 for gateway based IP address translation in communication networks, in accordance with aspects of the present disclosure. It should be understood that while FIG. 5 depicts just one particular arrangement and/or order of steps, other arrangements and/or orders of steps are possible and contemplated by the disclosed herein. For instance, one or more of the steps depicted in FIG. 5, may be performed in a different order or otherwise omitted.

At step 510 of the method 500, a data packet and an IPv4 address may be transmitted to a network gateway device, wherein the network gateway device is configured to communicate using an IPv6 protocol. For example, the client device(s) 110 may transmits a data packet and an IPv4 address to the network gateway device(s) 120.

At step 520 of method 500, based on transmitting the IPv4 address, cause the network gateway device to query a mapping table using the IPv4 address to determine an IPv6 address that is associated with the IPv4 address. For example, when the network gateway device(s) 120 receives the IPv4 address from the client device(s) 110, the IPv4 address may be used to query the network address mapping table 140 to determine an IPv6 address that corresponds to the IPv4 address.

At step 530 of the method 500, based on determining the IPv6 address, cause the network gateway device to transmit the packet of data to a destination associated with the IPv6 address. For example, once the IPv6 address is determined using the network address mapping table 140, the address translator 130 may transmit the data packet to a destination server 172 on a network 170, such as the Internet.

At step 540 of method 500, the IPv4 address and a second packet of data is transmitted to the network gateway device. For example, the client device(s) 110 may transmits a second data packet and the IPv4 address to the network gateway device(s) 120.

At step 550 of method 500, based on transmitting the IPv4 address and the second packet of data, cause the network gateway device to query the mapping table using the IPv4 address to determine the IPv6 address. For example, when the network gateway device(s) 120 receives the IPv4 address and the second data packet from the client device(s) 110, the IPv4 address may be used to query the network address mapping table 140 to determine an IPv6 address that corresponds to the IPv4 address.

At step 560 of method 500, cause the network gateway device to transmit the second packet of data to the destination associated with the IPv6 address. For example, once the IPv6 address is determined using the network address mapping table 140, the address translator 130 may transmit the second data packet to the destination server 172 on the network 170.

Referring now to FIG. 6, a diagram is depicted of an exemplary computing environment suitable for use in implementations of the present disclosure. In particular, the exemplary computer environment is shown and designated generally as computing device 600. Computing device 600 is but one example of a suitable computing environment and is not intended to suggest any limitation as to the scope of use or functionality of the invention. Neither should computing device 600 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 6, computing device 600 includes bus 602 that directly or indirectly couples the following devices: memory 604, one or more processors 606, one or more presentation components 608, input/output (I/O) ports 610, I/O components 612, power supply 614 and radio(s) 616. Bus 602 represents what may be one or more busses (such as an address bus, data bus, or combination thereof). Although the devices of FIG. 6 are shown with lines for the sake of clarity, in reality, delineating various components is not so clear, and metaphorically, the lines would more accurately be grey and fuzzy. For example, one may consider a presentation component, such as a display device to be one of I/O components 612. Also, processors, such as one or more processors 606, have memory. The present disclosure hereof recognizes that such is the nature of the art, and reiterates that FIG. 6 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 6 and refer to “computer” or “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data.

Computer storage media includes RAM, ROM, EEPROM, flash memory or other memory technology, CD-ROM, DVD or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared, and other wireless media. Combinations of any of the above should also be included within the scope of computer-readable media.

Memory 604 includes computer-storage media in the form of volatile and/or nonvolatile memory. Memory 604 may be removable, non-removable, or a combination thereof. Exemplary memory includes solid-state memory, hard drives, optical-disc drives, etc. Computing device 600 includes one or more processors 606 that read data from various entities, such as bus 602, memory 604, or I/O components 612. One or more presentation components 608 presents data indications to a person or other device. Exemplary one or more presentation components 608 include a display device, speaker, printing component, vibrating component, etc. I/O ports 610 allow computing device 600 to be logically coupled to other devices, including I/O components 612, some of which may be built in computing device 600. Illustrative I/O components 612 include a microphone, joystick, game pad, satellite dish, scanner, printer, wireless device, etc.

Radio 616 represents a radio that facilitates communication with a wireless telecommunications network. Illustrative wireless telecommunications technologies include CDMA, GPRS, TDMA, GSM, and the like. Radio 616 might additionally or alternatively facilitate other types of wireless communications including Wi-Fi, WiMAX, LTE, or other VoIP communications. As can be appreciated, in various embodiments, radio 616 can be configured to support multiple technologies and/or multiple radios can be utilized to support multiple technologies. A wireless telecommunications network might include an array of devices, which are not shown so as to not obscure more relevant aspects of the invention. Components, such as a base station, a communications tower, or even access points (as well as other components), can provide wireless connectivity in some embodiments.

Many different arrangements of the various components depicted, as well as components not shown, are possible without departing from the scope of the claims below. Embodiments of this technology have been described with the intent to be illustrative rather than be restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

1-8. (canceled)

9. A network addressing system comprising:
one or more processors; and
one or more computer storage hardware devices storing computer-usable instructions that, when used by the one or more processors, cause the one or more processors to:
receive, from a client device, a first DNS A query including an IPv4 address;
query a network mapping table for a first mapping of the IPv6 address to the IPv4 address;
determine that the network mapping table does not comprise the first mapping;
forward the first DNS A query to one or more DNS servers;
receive, from the one or more DNS servers, the IPv6 address that corresponds to the IPv4 address from the first DNS A query;
generate, in the network mapping table, the first mapping comprising the IPv4 address from the first DNS A query and the corresponding IPv6 address received from the one or more DNS servers;
receive, from the client device, a second DNS A query including the IPv4 address from the first DNS A query;
based on the second DNS A query, query the network mapping table for the first mapping of the IPv6 address to the IPv4 address;
from the first mapping, determine the IPv6 address that corresponds to the IPv4 address from the first DNS A query;
transmit, to the client device, the corresponding IPv6 address that was determined from the network mapping table.

10. The system of claim 9, wherein the first IP address is an IPv4 address and the second IP address is an IPv6 address.

11. The system of claim 9, wherein accessing the mapping table comprises generating a lookup request based on the first IP address.

12. The system of claim 11, wherein accessing the mapping table comprises searching the mapping table to determine a mapping of the first IP address to the second IP address.

13. The system of claim 9, wherein the mapping table is located on a network gateway device.

14. The system of claim 9, wherein the mapping table is generated using at least address data received from one or more DNS servers.

15. The system of claim 9, wherein generating a mapping of the first IP address to the second IP address comprises comparing a domain associated with the first IP address to an allow-list or deny-list.

16. One or more non-transitory computer-readable media having computer-executable instructions embodied thereon that, when executed, perform a method for determining an IP address, the method comprising:
transmitting an IPv4 address and a packet of data to a network gateway device, wherein the network gateway device is configured to communicate using an IPv6 protocol;
based on transmitting the IPv4 address, causing the network gateway device to query a mapping table stored on one or more storage components of the network gateway device using the IPv4 address to determine an IPv6 address that is associated with the IPv4 address without creating a synthesized IPv6 address; and
based on determining the IPv6 address, causing the network gateway device to transmit the packet of data to a destination associated with the IPv6 address without conversion back to an IPv4 address by a network address translation component external to the network gateway device.

17. The one or more non-transitory computer-readable media of claim 16, wherein querying the mapping table comprises generating a lookup request.

18. The one or more non-transitory computer-readable media of claim 17, wherein the lookup request comprises the IPv4 address, a domain name associated with the IPv4 address, or a domain alias associated with the IPv4 address.

19. The one or more non-transitory computer-readable media of claim 16, wherein the mapping table comprises a set of mappings from a set of IPv4 addresses to a set of IPv6 addresses.

20. The one or more non-transitory computer-readable media of claim 19, wherein a mapping of the set of mappings was generated in response to an IP address query to a DNS server.

21. A method comprising:
receiving, at a network gateway device, a DNS query from a first user device, the DNS query comprising a domain name;
determining, based on a query of one or more computer storage components of the network gateway device, an IPv4 address associated with the domain name without the network gateway device forwarding the DNS query to a DNS server external to the network gateway device;
receiving, at the network gateway device, a data packet from the first user device and destined for the IPv4 address associated with the domain name;
mapping, based on a query of the one or more storage components of the network gateway device, the IPv4 address to a second IP address, wherein the second IP address comprises an IPv6 address for the domain name; and
transmitting the data packet to an external network destination having the second IP address via a network address translation component without conversion to IPv4 by a service provider address translator external to the network gateway device, wherein the network gateway device is connected to the first user device on a first network using an IPv4 protocol and the network gateway device is connected to the external network destination on a second network using an IPv6 protocol via a wireless telecommunications network.

22. The system of claim 9, wherein the network mapping table is configured to:
receive, from a remote server, one or more IPv6 addresses that correspond with one or more IPv4 addresses;
store mapping(s) of the IPv4 addresses to the corresponding IPv6 addresses; and
provide the network addressing system an IPv6 address that corresponds to the IPv4 address in a first DNS A query.

23. The system of claim 9, further configured to:
receive, from a client device, a communication bound for a destination device, using a first network protocol;
forward the communication to the destination device, using a second network protocol;
receive, from the destination device, a communication response using the second network protocol; and
forward the communication response to the client device, using the first network protocol.

24. The system of claim 23, wherein the first network protocol is Wi-Fi.

25. The system of claim 23, wherein the second network protocol is a wireless telecommunications network protocol.

26. The system of claim 25, wherein the wireless telecommunications network protocol is LTE.
